(19) United States
(12) Patent Application Publication
(10) Pub. No.: US 2005/0214201 A1
(43) Pub. Date: Sep. 29, 2005

(54) Method for producing an alpha-alumina powder

(75) Inventors: Shinobu Maruno, Niihama-shi (JP); Hajime Maki, Niihama-shi (JP); Yoshiaki Takeuchi, Niihama-shi (JP)

Correspondence Address: AKIN GUMP STRAUSS HAUER & FELD L.L.P., ONE COMMERCE SQUARE, 2005 MARKET STREET, SUITE 2200, PHILADELPHIA, PA, 19103, US

(73) Assignee: Sumitomo Chemical Company, Limited

(21) Appl. No.: 11/079,163

(22) Filed: Mar. 14, 2005

(30) Foreign Application Priority Data
Mar. 16, 2004 (JP) 2004-074113
Aug. 10, 2004 (JP) 2004-233087
Sep. 3, 2004 (JP) 2004-256680
Sep. 3, 2004 (JP) 2004-256682

(51) Int. Cl. C01F 7/02

(52) U.S. Cl. 423/625

(57) ABSTRACT

The present invention provides a method for producing an α-alumina powder. The method for producing an α-alumina powder comprises steps of: (1) pulverizing a metal compound having a full width at half maximum (Ho) of a main peak in XRD pattern to obtain a seed crystal having a full width at half maximum (H) of the main peak in XRD pattern, (2) mixing the obtained seed crystal with an aluminum compound, (3) calcining the mixture, and wherein a ratio of H/Ho is 1.06 or more.

### BACKGROUND OF THE INVENTION

1. Field of the Invention

The present invention relates to a method for producing an α-alumina powder having a high α-ratio, large BET specific surface area to provide a small amount of α-alumina particles having necking.

2. Description of Related Art

α-alumina is one of aluminum oxides, which is represented by formula Al₂O₃ and has a corundum structure, and widely used as a raw material for producing a sintered body such as a translucent tube.

From the standpoint of improvement in the strength of a sintered body, α-alumina used as a raw material is required to have a high α-ratio, large BET specific surface area, and to provide a small amount of α-alumina particles having necking.

### SUMMARY OF THE INVENTION

The present inventors have investigated a method for producing an α-alumina powder, resultantly leading to completion of the present invention.

Namely, the present invention provides a method for producing an α-alumina powder comprising steps of:
(1) pulverizing a metal compound having a full width at half maximum (hereinafter abbreviated to “FWHM”)(Ho) of a main peak in X-ray diffraction (hereinafter abbreviated to “XRD”) pattern to obtain a seed crystal having FWHM (H) of the main peak in XRD pattern,
(2) mixing the obtained seed crystal with an aluminum compound,
(3) calcining the mixture, and
wherein a ratio of H/Ho is 1.06 or more.

### BRIEF EXPLANATION OF THE DRAWINGS

FIG. 1 shows a method to calculate FWHM Ho of a metal compound and FWHM H of a seed crystal.

FIG. 2 shows an example of transmission electron micrograph (hereinafter abbreviated to “TEM”) of α-alumina powder.

FIG. 3 shows a XRD pattern of a metal compound.

FIG. 4 shows a XRD pattern of a seed crystal used in Example 1.

FIG. 5 shows a TEM of an α-alumina powder obtained in Example 1.

FIG. 6 shows a XRD pattern of a seed crystal used in Example 2.

FIG. 7 shows a TEM of an α-alumina powder obtained in Example 2.

### DETAILED DESCRIPTION OF THE PREFERRED EMBODIMENTS

The method for producing an α-alumina powder of the present invention comprises a step (1) of pulverizing a metal compound having a FWHM(Ho) of a main peak in XRD pattern to obtain a seed crystal having FWHM (H) of the main peak in XRD pattern.

The metal compound may advantageously be that promoting phase transformation from an aluminum compound into α-alumina in calcination described later. Examples of the metal compounds include metal oxides such as α-alumina(Al₂O₃), α-iron oxide(Fe₂O₃) and α-chromium oxide(Cr₂O₃); metal hydroxides such as diaspore (AlOOH), preferably metal oxides, and further preferably α-alumina.

Pulverizing may be conducted in dry or wet process, and batch-wise or continuous process. Dry pulverizing may advantageously be conducted, for example, by using a pulverizer such as ball mill, vibration mill, planetary mill, pin mill, medium-agitating mill and jet mill. In dry pulverizing, it is preferable to decrease contamination, and for this, it is recommended to use alumina, preferably alumina having a purity of 99% by weight or more as the material of member, which is contacted with the aluminum compound, such as pulverizing medium, vessel, nozzle and liner.

Dry pulverizing may be conducted in the presence of pulverizing agent. Examples of the pulverizing agent include alcohols such as ethanol, propanol; glycols such as propylene glycol, polypropylene glycol, ethylene glycol and polyethylene glycol; amines such as triethanol amine; fatty acids such as palmitic acid, stearic acid and oleic acid; metal alkoxide such as aluminum alkoxide; carbon materials such as carbon black and graphite. The pulverizing agent may be used independently or two or more of them may be used in combination. The amount of the pulverizing agent is usually about 0.01 parts by weight or more, preferably about 0.5 parts by weight or more, further preferably about 0.75 parts by weight or more and usually about 10 parts by weight or less, preferably about 5 parts by weight or less, further preferably 2 parts by weight or less based on 100 parts by weight of the metal compound.

Wet pulverizing may be conducted, for example, by using a pulverizer such as pin mill and medium-agitating mill. In wet pulverizing, it is also preferable to decrease contamination, and for this, it is recommended to use alumina, preferably alumina having a purity of 99% by weight or more as the material of member, which is contacted with the aluminum compound, such as pulverizing medium, vessel and liner. Wet pulverizing is usually conducted in the presence of water. Wet pulverizing may be conducted further in the presence of dispersant or surfactant. Examples of the dispersant include acids such as nitric acid, hydrochloric acid, sulfuric acid, acetic acid and oxalic acid; alcohols such as methanol, ethanol, isopropyl alcohol; aluminum salts such as aluminum nitrate, aluminum chloride, aluminum oxalate and aluminum acetate. Examples of the surfactant include anionic surfactants, cationic surfactants, nonionic surfactants and amphoteric surfactants.

Further, the seed crystal obtained by pulverizing may be classified. By classification, 50% by weight or more, preferably 70% by weight or more, further preferably 90% by weight or more of coarse particles (for example, particles with a particle diameter of about 1 μm or more) may be removed from the seed crystal.

The seed crystal obtained in the above method has an average primary particle diameter of usually about 0.01 μm or more, preferably about 0.05 μm or more, and usually about 0.5 μm or less. The seed crystal has a BET specific surface area of usually about 12 m²/g or more, preferably about 15 m²/g or more, and usually about 150 m²/g or less.

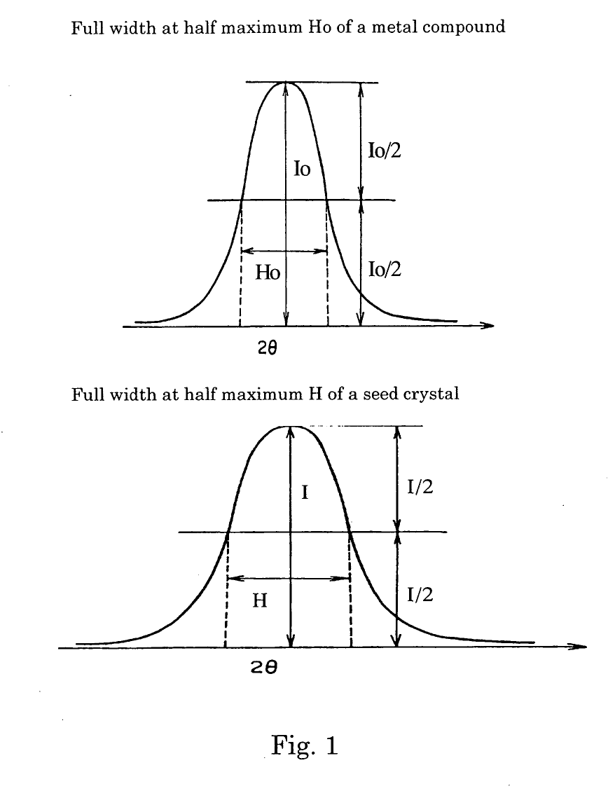

Pulverizing is conducted under conditions which change a metal compound having FWHM of Ho into a metal compound having FWHM of H, wherein the ratio of H to Ho is about 1.06 or more, preferably about 1.08 or more, and usually about 5 or less, preferably about 4 or less, further preferably about 3 or less. The ratio of H/Ho represents a degree of pulverizing, and is calculated from FWHM(Ho) of a main peak between 45 degrees and 70 degrees in XRD pattern measure before pulverizing and FWHM(H) of the main peak in XRD pattern measured after pulverizing as shown in FIG. 1.

When a metal compound is α-alumina and X-ray source is CuK α beam, the ratio of H/Ho represents may be calculated from FWHM(Ho) of alumina(116) diffraction peak observed at 2θ of about 57.5 degree, in XRD pattern before pulverizing, and FWHM(H) of the alumina(116) diffraction peak in XRD pattern after pulverizing.

Regarding α-iron oxide (Fe₂O₃), α-chromium oxide(Cr₂O₃) or diaspore(AlOOH), a main peak thereof between 45 degrees and 70 degrees, which is usually a peak of (116), is observed at near position to that of α-alumina in XRD pattern measured using CuKα beam as X-ray source.

The method of the present invention comprises further a step (2) of mixing the obtained seed crystal with an aluminum compound.

The aluminum compound may be a compound converting into α-alumina by calcination described later, and examples thereof include aluminum hydroxide, transition alumina, aluminum salt, hydrolysate of aluminum salt, hydrolysate of aluminum alkoxide.

The aluminum hydroxide is, for example, a crystalline compound in which a crystal phase is gibbsite, boehmite, pseudo-boehmite, bayerite, norstrandite or diaspore, or an amorphous compound.

The transition alumina is, for example, that in which a crystal phase is γ, χ, θ, ρ or κ.

The aluminum salt is, for example, an inorganic aluminum salt such as aluminum nitrate, aluminum sulfate, aluminum ammonium sulfate and ammonium aluminum carbonate hydroxide; or an organic aluminum salt such as aluminum oxalate, aluminum acetate, aluminum stearate, ammonium alum, aluminum lactate and aluminum laurate.

The hydrolysate of aluminum salt is, for example, a hydrolysate of a water-soluble aluminum compound, and examples of the hydrolysate include those obtained by mixing an aluminum salt (inorganic aluminum salt, organic aluminum salt) with a base in the presence of water or hydrolyzing the aluminum salt. The concentration of the aluminum salt in the aqueous solution is usually from about 0.01 mol/L to saturation concentration in terms of Al₂O₃ and pH is usually from about 0 to about 2. It is preferable that an aluminum salt is completely dissolved in water. The aqueous solution of aluminum salt may contain an organic solvent, and the organic solvent may be one which vaporizes or decomposes in calcination described later, and examples thereof include polar organic solvents such as methanol, ethanol, n-propanol and isopropanol and non-polar organic solvents such as carbon tetrachloride, benzene and hexane. The base is a compound containing no metal component such as aqueous ammonia, ammonia gas, ammonium carbonate and ammonium hydrogencarbonate. The concentration of the base is about 1% by weight or more, and about 50% by weight or less, preferably about 25% by weight or less. Hydrolysis may be conducted at pH of usually 3 or more, and preferably 5 or less, and temperature of about 60° C. or less, preferably about 50° C. or less, further preferably about 45° C. or less, and not lower than the freezing point of the above-mentioned aqueous solution, preferably about 0° C. or more, for about 1 hour to about 72 hours.

The aluminum alkoxide is, for example, aluminum isopropoxide, aluminum ethoxide, aluminum sec-butoxide or aluminum t-butoxide.

The hydrolysate of aluminum alkoxide is, for example, a hydrolysate of aluminum isopropoxide, aluminum ethoxide, aluminum sec-butoxide or aluminum t-butoxide, and examples thereof include those obtained by mixing water having a pH of usually 3 or more, preferably 5 or less with the aluminum alkoxide. The water having a pH of from 3 to 5 may be prepared by adding an acid (nitric acid or the like) to water. The aluminum alkoxide may contain an organic solvent, and the organic solvent may be one which vaporizes or decomposes in calcination described later, and examples thereof include polar organic solvents such as methanol, ethanol, n-propanol and isopropanol and non-polar organic solvents such as carbon tetrachloride, benzene and hexane. Hydrolysis may be conducted at pH of usually 3 or more, preferably 5 or less, and temperature of about 60° C. or less, preferably about 50° C. or less, further preferably about 45° C. or less, and usually 0° C. or more, for about 1 hour to about 72 hours.

The mixture obtained by hydrolysis may usually contain a hydrolysate and water. Since the hydrolysate is usually insoluble in water, the mixture may be in form of a sol or gel, or contain a precipitate of a hydrolysate.

Mixing in step (2) may be conducted, for example, by a method (a) of mixing a seed crystal with at least one selected from the group consisting of aluminum hydroxide, transition alumina, hydrolysate of aluminum salt and hydrolysate of aluminum alkoxide; a method (b) of mixing a seed crystal with an aluminum salt; a method (c) of mixing a seed crystal with an aluminum alkoxide.

The amount of the seed crystal is usually about 1 parts by weight or more, preferably about 2 parts by weight or more, further preferably about 4 parts by weight or more and usually about 50 parts by weight or less, preferably about 40 parts by weight or less, further preferably 25 parts by weight or more based on 100 parts by weight of the total amount of the seed crystal and the aluminum compound, which is at least one selected from the group consisting of aluminum hydroxide, transition alumina, hydrolysate of aluminum salt and hydrolysate of aluminum alkoxide, aluminum salt and aluminum alkoxide.

In the method (a) or (b), the mixing may be conducted in the presence of water. The amount of water is usually about 150 parts by weight or more, preferably about 200 parts by weight or more and usually about 1000 parts by weight or less, preferably about 500 parts by weight or less based on 100 parts by weight of the total amount of the seed crystal and the aluminum compound.

In the method (b) or (c), it is preferable that the following equation is satisfied,
W≧350/S
wherein W (parts by weight in terms of metal oxide such as Al₂O₃, Fe₂O₃, Cr₂O₃) is an amount of the seed crystal based on 100 parts by weight in terms of Al₂O₃ of the total amount of the seed crystal and the aluminum compound, and s (m²/g) is a BET specific surface area of the seed crystal. It is further preferable that the following equation is satisfied.
7500/s≧W≧400/S
A mixture of seed crystal and aluminum salt or aluminum alkoxide may further be subjected to hydrolysis. The hydrolysis may be conducted at pH of usually 3 or more, preferably 5 or less, and temperature of about 60° C. or less, preferably about 50° C. or less, further preferably about 45° C. or less, and 0° C. or more, for about 1 hour to 72 hours.

The obtained mixture may further be subjected to drying. Drying may be conducted at temperature of usually about 100° C. or less by using freeze dryer, vacuum dryer or the like.

Furthermore, The obtained mixture may be heated. The heating may be conducted at a temperature of less than the temperature at which the aluminum compound transforms to an α-alumina. The heating temperature is usually about higher than 100° C., preferably about 300° C. or higher, and usually lower than about 600° C.

In case heating is conducted by using a furnace equipped with inlet to feed the mixture and gas, and outlet to withdraw the mixture and gas such as rotary furnace used in Example 1, it is preferable that the heating conditions satisfy following equation.

$$x ≦ \frac{PA}{nRT} ( ρ - \frac{{V}_{2} T}{{AT}_{0}} )$$

wherein x(g/sec) is a feed rate of the mixture, which contains hydrolysate of aluminum compound,
V₂(Normal-m³/sec) is a feed rate of inert gas,
P(Pa) is a pressure of atmosphere in the furnace,
A(m²/g) is an open surface area in the outlet,
n(mol/g) is a molar amount of gas generated from 1 g of the mixture
R is a gas constant(=8.31 Pa·m³/mol/K),
T(K) is a temperature of outlet in the furnace,
To(K) is a temperature of atmosphere outside the furnace and
ρ(m/sec) is a flow rate of gas discharged from outlet.

The method of the present invention comprises further a step (3) of calcining the mixture obtained above.

The calcination may advantageously be conducted by using an apparatus such as a tubular electric furnace, box-type electric furnace, tunnel furnace, far-infrared furnace, microwave furnace, shaft furnace, reflection furnace, rotary furnace and Roller Hearth furnace. The calcination may be conducted in batch-wise or continuous. It may be conducted in static mode or flow mode.

The calcination temperature is not lower than the temperature at which the aluminum compound transforms to an α-alumina, usually 600° C. or higher, preferably about 700° C. or higher and usually about 1000° C. or lower, preferably about 950° C. or lower. The calcination time is usually 10 minutes or more, preferably about 30 minutes or more and usually about 24 hours or less, preferably about 10 hours or less.

The calcination is usually conducted under air or an inert gas such as N₂ and Ar. The calcination may also be conducted under air having controlled partial pressure of water vapor, for example, air having a partial pressure of water vapor of 600 Pa or less.

The obtained α-alumina powder may be subjected to pulverizing. The pulverizing may be conducted, for example, by using a medium pulverizer such as a vibration mill and a ball mill, or an pneumatic pulverizer such as a jet mill. Further, the α-alumina powder may be subjected to classification.

An α-alumina powder obtained by the method of the present invention has an average particle diameter of usually about 0.01 μm or more, preferably about 0.05 μm or more, and usually about 0.1 μm or less, preferably about 0.09 μm or less, α-ratio is about 90% or more, preferably about 95% or more and BET specific surface area of about 15 m²/g or more, preferably about 17 m²/g or more and about 50 m²/g or less.

The α-alumina powder has, as described above, a high α-ratio and large BET specific surface area and has a small amount of particle having necking, therefore, this powder is useful as a raw material for producing an α-alumina sintered body with high strength. The resulted α-alumina sintered body is suitable as a member for which high strength is required such as a cutting tool, bioceramics, low-resistance routing pattern ceramics (for example, alumina ceramics with copper patter thereon) and bulletproof board. The α-alumina sintered body is, due to chemical stability such as excellent corrosion resistance, used as a part of an apparatus for producing a semiconductor such as a wafer handler; an electronic part such as an oxygen sensor; a translucent tube such as a sodium lamp and metal halide lamp; or a ceramic filter. A ceramics filter is used for removal of solid components contained in a exhaust gas, for filtration of aluminum melt, filtration of drinks such as beer, or selective permeation of a gas produced at petroleum processing or CO, CO₂, N₂, O₂, H₂ gas. The α-alumina powder may be used as a sintering agent for ceramics such as thermally conductive ceramics (for example, AlN), YAG and phosphors.

Further, the α-alumina powder may be used as an additive for toner or resin filler. for improving head cleaning property and friction resistance by addition thereof to an application layer of a magnetic medium of application type. Also, the α-alumina powder may be used as an additive for cosmetics or brake lining.

Furthermore, the α-alumina powder is used as a polishing material. For example, a slurry obtained by dispersing an α-alumina powder in a medium such as water is suitable for polishing of semiconductor CMP and polishing of a hard disk substrate. A polishing tape obtained by coating an α-alumina particle on the surface of a tape is suitable for precise polishing of a hard disk and magnetic head.

### EXAMPLES

The present invention is described in more detail by following Examples, which should not be construed as a limitation upon the scope of the present invention. The properties of an α-alumina and a seed crystal were evaluated as follows.

(1) α-Ratio

It is calculated according to the following equation (i) using the peak strength I_{25.6} at 2θ=25.6°, which is corresponding to a peak intensity of α-alumina (012) and the peak strength I₄₆ at 2θ=46°, which is corresponding to a peak intensity of alumina other than α-alumina, from a diffraction spectrum measured under conditions of radiation source: CuKα beam, 40 kV×20 mA, monochrometer:

graphite, by using a powder X-ray diffractometer:
α-ratio=I_{25.6}/(I_{25.6}+I₄₆)×100(%) (i)
(2) Average Primary Particle Diameter

From a transmission electro micrograph of α-alumina powder, the maximum diameter along constant direction of each primary particle of any 20 or more particles was measured, and an average value of measured values was calculated.

(3) BET Specific Surface Area

It was measured by using specific surface area analyzer (trade name “FLOWSORB II 2300”, manufactured by SHIMADZU CORPORATION) with a nitrogen adsorption method.

(4) Degree of Pulverizing

XRD spectrums of the seed crystal (a-alumina) before and after pulverizing operations were measured by a X-ray diffractometer. The full widths at half maximum of a phase(116), i.e. H0(116)(before) and H(116)(after), were obtained from the XRD spectrums, followed by calculation by the equation (ii)
Degree of pulverizing=H(116)/H0(116) (ii)

(5) Degree of Necking

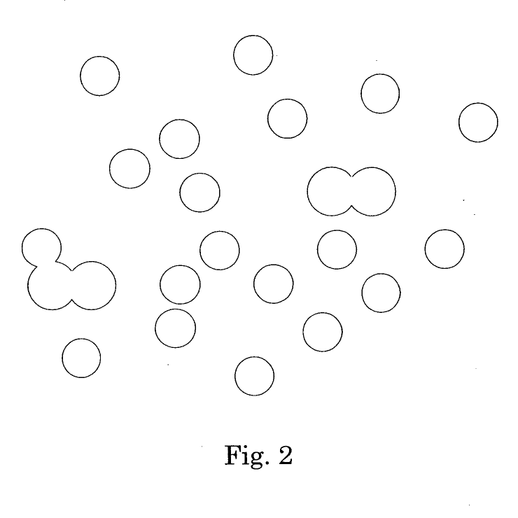

Among 20 or more of particles on a transmission electron micrograph of α-alumina powder, the ratio of those in form of agglomerated two or more primary particles was calculated. The measuring method will be explained by following example as demonstrated in FIG. 2.
In the diagram:
Particles in form of no agglomerated primary particles: 18
Particle in form of agglomerated two primary particles: 1
Particle in form of agglomerated three primary particles: 1
In this case, degree of necking was 10%[=2/(18+1+1)]

### Example 1

[Preparation of Metal Compound (α-Alumina)]

The aluminum hydroxide was obtained by hydrolyzing an aluminum isopropoxide, followed by pre-calcination to obtain a transition alumina in which the major crystal phase was θ phase and 3% by weight of α phase was contained; the transition alumina was pulverized by a jet mill to obtain a powder having a bulk density of 0.21 g/cm³.

The obtained powder was calcined by a furnace filled with an air of −15° C. of dew point (partial pressure of water vapor: 165 Pa) in the following conditions:

mode: continuous feeding and discharging,

average retention time: 3 hours,

maximum temperature: 1170° C.,

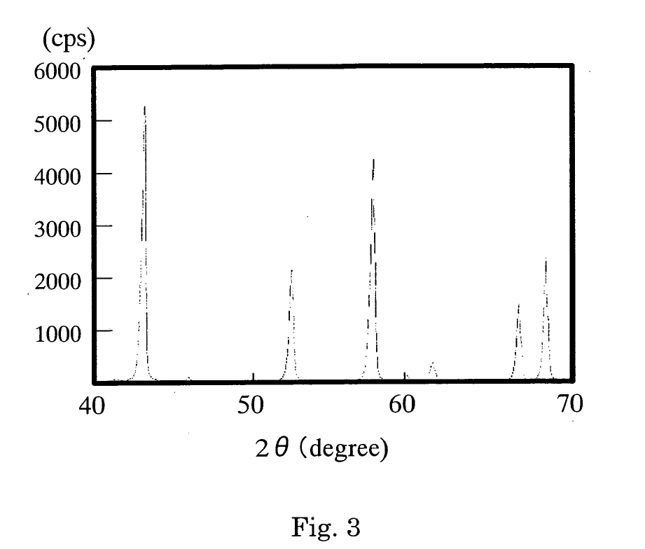

then α-alumina having full widths at half maximum of Ho₍₁₁₆₎, BET specific surface area of 14 m³/g was obtained. An XRD pattern of the α-alumina is shown in FIG. 3.

[Pulverization of α-Alumina]

100 parts by weight of the α-alumina and 1 part by weight of a propylene glycol as a pulverizing agent were charged into a vibration mill to pulverize the α-alumina powder in the following conditions:

media: alumina beads having a diameter of 15 mm

retention time: 12 hours,

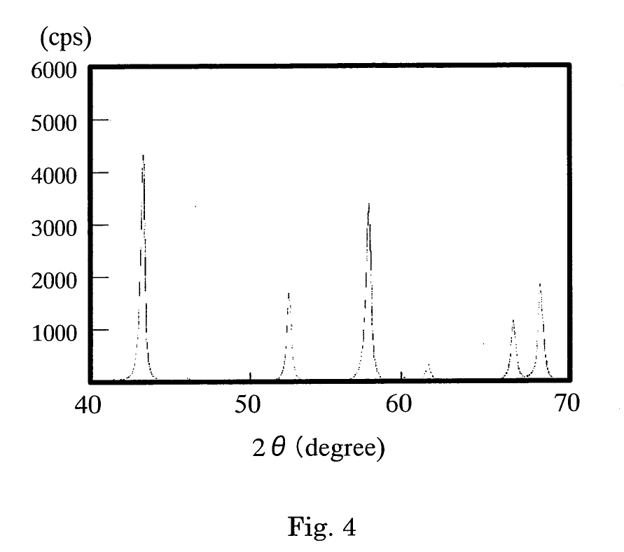

consequently, a seed crystal having a full widths at half maximum of H₍₁₁₆₎ and BET specific surface area of 17.2 m³/g, and average particle diameter of 0.1 μm was obtained. An XRD pattern of the seed crystal is shown in FIG. 4. In this example, a degree of pulverizing of H₍₁₁₆₎/Ho₍₁₁₆₎ is 1.1.

[Preparation of Seed Crystal Slurry]

In 150 g of 0.01 mole/L aqueous aluminum nitrate solution, 37.5 g of the seed crystal dispersed to obtain a slurry. In a plastic vessel having an inner volume of 1 L, the slurry and 700 g of alumina beads having a diameter of 2 mm were charged into, and then agitated. The content of the vessel was taken out to remove the alumina beads by filtration, then the seed crystal slurry was obtained.

[Mixing of Seed Crystal and Aluminum Compound]

750.26 g (2 moles) of aluminum nitrate nonahydrate (Al(NO₃)₃·9H₂O) (manufactured by Kansai Catalyst Co., Ltd., reagent grade, appearance: powder) was dissolved in 1555.7 g of water to obtain an aluminum nitrate solution. The aluminum nitrate solution was added with 218.6 g of seed crystal described above (43.4 g in terms of Al₂O₃), and then further added under agitation at a room temperature with 340.46 g of 25% aqueous ammonium (manufactured by Wako Pure Chemical Industries, Ltd., special reagent grade), that is 85.12 g (5 moles) in terms of NH₃, at the feed rate of 32 g/minute by a micro rotary pump to obtain a mixture. The obtained mixture had a pH of 3.9. The mixture was maintained at a room temperature, followed by drying at 60° C., then pulverized with a mortar to obtain a mixed powder. The mixed powder contained 85 g (in terms of Al₂O₃)of amorphous alumina, 390 g (in terms of NH₄NO₃) of ammonium nitrate, 71 g (in terms of Al(NO₃)₃)of aluminum nitrate and seed crystal. The amount of the seed crystal in terms of Al₂O₃ was 30 parts by weight per 100 parts by weight of the mixed powder.

[Calcination]

The mixed powder was pre-calcined by using a rotary furnace (manufactured by Takasago Industry Co., Ltd.) having inner volume of 79L in the following conditions:

mode: continuous feeding, continuous discharging,

feed rate of powder: 20 g/minute,

furnace temperature
inlet: 490° C.
outlet: 390° C.,

pressure: 0.1 MPa

feed rate of gas: 10 normal L-nitrogen (N₂)/minute,

flow rate of discharge gas: 2.8 m/second

rotational speed of rotary furnace: 2 rpm.

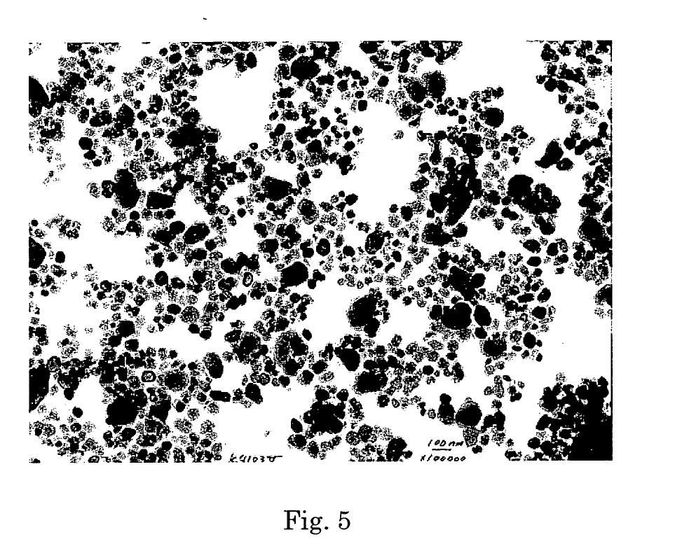

The mixed powder generated 34.7×10⁻³ mole of gas based on 1 g of the mixed powder. The powder discharged from the rotary furnace was put in a crucible made of alumina, followed by putting the crucible in the furnace. Thereafter, the powder was heated up to 920° C. at the temperature raising rate of 300° C./hour, followed by maintaining at 920° C. for 3 hours to calcine. The properties of the α-alumina powder are shown in Table 1. A TEM of an obtained α-alumina powder is shown in FIG. 5.

### Example 2

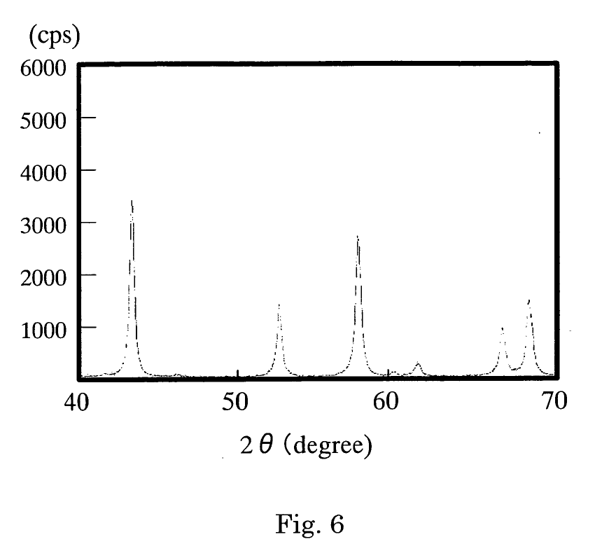

A seed crystal slurry obtained in [Preparation of seed crystal slurry] of Example 1 was centrifuged in condition of rotational speed: 4000 rpm, for 40 minutes to obtain a supernatant containing 3.3% by weight of a fine α-alumina crystal seed having a BET specific surface area of 38.1 m²/g. An XRD pattern of the seed crystal is shown in FIG. 6. In this example, a degree of pulverizing H₍₁₁₆₎/Ho₍₁₁₆₎ is 1.38.

375.13 g (1 mole) of aluminum nitrate nonahydrate (Al(NO₃)₃·9H₂O) (manufactured by Kansai Catalyst Co., Ltd., reagent grade, appearance: powder) was dissolved in 777.87 g of water to obtain an aluminum nitrate solution. The aluminum nitrate solution was added with 171.7 g of seed crystal described above (5.67 g in terms of Al₂O₃), and then further added under agitation at a room temperature with 161.7 g of 25% aqueous ammonium (manufactured by Wako Pure Chemical Industries, Ltd., special reagent grade), that is 40.422 g in terms of NH₃, at the feed rate of 32 g/minute by a micro rotary pump to obtain a mixture. The mixture obtained had a pH of 3.9. The mixture was maintained at a room temperature, followed by drying at 60° C. , then pulverized with a mortar to obtain a mixed powder. The mixed powder contained 85 g (in terms of Al₂O₃)of amorphous alumina, 390 g (in terms of NH₄NO₃) of ammonium nitrate, 71 g (in terms of Al(NO₃)₃)of aluminum nitrate and seed crystal. The amount of the seed crystal in terms of Al₂O₃ was 10 parts by weight per 100 parts by weight of the mixed powder.

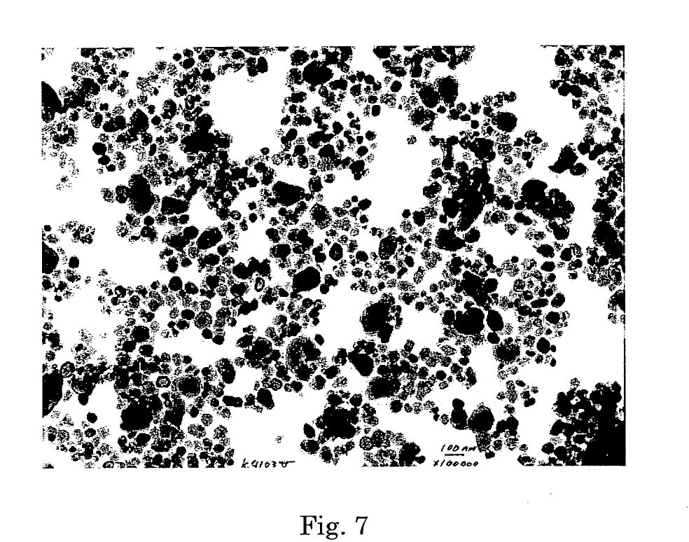

The same operation as in [calcination] of Example 1 was conducted excepting that the calcination temperature was changed to 900° C. The properties of the α-alumina powder are shown in Table 1. A TEM of an obtained α-alumina powder is shown in FIG. 7.

TABLE 1
Properties of α-Alumina Powder

| | Example | Example |
|---|---|---|
| | 1 | 2 |
| α-ratio (%) | 98 | 98 |
| BET specific surface | 16.9 | 18.8 |
| area (m³/g) | | |
| Average primary particle | 57 | 74 |
| diameter (μm) | | |
| Degree of necking (%) | 8 | 17 |

1. A method for producing an α-alumina powder comprising steps of:
(1) pulverizing a metal compound having a full width at half maximum (Ho) of a main peak in XRD pattern to obtain a seed crystal having a full width at half maximum (H) of the main peak in XRD pattern,
(2) mixing the obtained seed crystal with an aluminum compound,
(3) calcining the mixture, and
wherein a ratio of H/Ho is 1.06 or more.

2. The method for producing an α-alumina powder according to claim 1, wherein the metal compound is at least one selected from the group consisting of metal oxides and metal hydroxides.

3. The method for producing an α-alumina powder according to claim 2, wherein the metal compound is at least one selected from the group consisting of α-Al₂O₃, α-Fe₂O₃, α-Cr₂O₃ and diaspore

4. The method for producing an α-alumina powder according to claim 1, wherein the ratio of H/Ho is 5 or less.

5. The method for producing an α-alumina powder according to claim 1, wherein the aluminum compound is at least one selected from the group consisting of aluminum hydroxide, transition alumina, aluminum salt, hydrolysate of aluminum salt, aluminum alkoxide and hydrolysate of aluminum alkoxide.

6. The method for producing an α-alumina powder according to claim 5, wherein the aluminum compound is at least one selected from the group consisting of aluminum salt and aluminum alkoxide.

7. The method for producing an α-alumina powder according to claim 6, wherein the amount of the seed crystal W (parts by weight in terms of oxide based on 100 parts by weight in terms of Al₂O₃ of the total amount of the seed crystal) and a BET specific surface area of the seed crystal s (m²/g) satisfy the following equation.
W≧350/S

8. The method for producing an α-alumina powder according to claim 1, wherein the aluminum compound is at least one selected from the group consisting of aluminum hydroxide, transition alumina, aluminum salt, hydrolysate of aluminum salt and hydrolysate of aluminum alkoxide.

9. The method for producing an α-alumina powder according to claim 8, wherein the mixing is conducted in the presence of water.

10. The method for producing an α-alumina powder according to claim 9, wherein the amount of water is from about 150 to about 1000 parts by weight based on 100 parts by weight of the total amount of the aluminum compound and the seed crystal.

11. The method for producing an α-alumina powder according to claim 5, wherein the aluminum compound is an aluminum salt.

12. The method for producing an α-alumina powder according to claim 11, which comprises further a step of mixing a base to the mixture in step (2), to hydrolyze the aluminum compound.

13. The method for producing an α-alumina powder according to claim 12, wherein the hydrolysis is conducted at pH of 3 or more.

14. The method for producing an α-alumina powder according to claim 13, wherein the hydrolysis is conducted at pH of from 3 to 5.
